(19) United States
(12) Patent Application Publication
(10) Pub. No.: US 2007/0183093 A1
(43) Pub. Date: Aug. 9, 2007

(54) Protective layer for CMP assisted lift-off process and method of fabrication

(76) Inventors: Quang Le, San Jose, CA (US); Jui-Lung Li, San Jose, CA (US); Yi Zheng, San Ramon, CA (US)

Correspondence Address: INTELLECTUAL PROPERTY LAW OFFICES, 1901 SOUTH BASCOM AVENUE, SUITE 660, CAMPBELL, CA, 95008, US

(21) Appl. No.: 11/350,345

(22) Filed: Feb. 7, 2006

(51) Int. Cl. G11B 5/147

(52) U.S. Cl. 360/126

(57) ABSTRACT

A magnetic head is disclosed having a write head with an encapsulated protected pole structure, which includes a P3 pole tip. A protective layer surrounds at least a portion of the P3 pole tip, and an encapsulating material layer surrounds a portion of the protective layer. Also disclosed is a method of fabrication for a write head with an encapsulated protected pole structure.

### BACKGROUND OF THE INVENTION

1. Field of the Invention

The present invention relates to heads for high track density perpendicular magnetic recording, and more particularly relates to fabrication of magnetic poles of such heads.

2. Description of the Prior Art

Data has been conventionally stored in a thin magnetic media layer adjacent to the surface of a hard drive disk in a longitudinal mode, i.e., with the magnetic field of bits of stored information oriented generally along the direction of a circular data track, either in the same or opposite direction as that with which the disk moves relative to the transducer.

More recently, perpendicular magnetic recording systems have been developed for use in computer hard disk drives. A typical perpendicular recording head includes a trailing write pole, a leading return or opposing pole magnetically coupled to the write pole, and an electrically conductive magnetizing coil surrounding the write pole. In this type of disk drive, the magnetic field of bits of stored information are oriented normally to the plane of the thin film of magnetic media, and thus perpendicular to the direction of a circular data track.

Media used for perpendicular recording typically include a magnetically hard recording layer and a magnetically soft underlayer which provides a flux path from the trailing write pole to the leading opposing pole of the writer. Current is passed through the coil to create magnetic flux within the write pole. The magnetic flux passes from the write pole tip, through the hard magnetic recording track, into the soft underlayer, and across to the opposing pole, completing a loop of flux.

Perpendicular recording designs have the potential to support much higher linear densities than conventional longitudinal designs. Magnetization transitions of data bits on the bilayer recording disk are recorded by a trailing edge of the trailing pole and reproduce the shape of the trailing pole projection on the media plane, thus the size and shape of the pole tip is of crucial importance in determining the density of data that can be stored.

Perpendicular magnetic recording is expected to supersede longitudinal magnetic recording due to the ultra-high density magnetic recording that it enables. Increases in areal density have correspondingly required devising fabrication methods to substantially reduces the width of the P3 write pole tip while maintaining track-width control (TWC) and preserving trailing edge structural definition (TED). As mentioned above, the writing process reproduces the shape of the P3 write pole projection on the media plane, so the size of the P3 limits the size of the data fields and thus the areal density. The current drive is to make P3 poles of less than 200 nm (200×10⁻⁹ meters). Making reliable components of such microscopic size has been a challenge to the fabricating process arts. This problem is made even more challenging because the P3 pole shape at the ABS is preferably not a simple rectangle, but is trapezoidal, with parallel top and bottom edges, but a bevel angle preferably of approximately 8 to 15 degrees on the side edges. This is primarily done so that the P3 pole tip fits into the curved concentric tracks without the corners extending into an adjacent track by mistake.

Various approaches have been tried in an effort to shape such tiny components. Ion milling (IM) is a process that has been long used in the manufacture and shaping of such micro-components, but here there is the difficulty of maintaining the top edge dimension while trying to cut the side bevels. Initially, alumina was used as an IM hard mask for reliable beveled (8-15 degree) track-width definition (TWD) in the 330-300 nm range but was later changed to carbon to further extend the IM process to smaller dimensions. The complication in developing an IM scheme is the inability to consistently achieve a TWC process and preserve TED due to insufficient resistance of the hard mask to passivate TED. Carbon such as diamond-like-carbon (DLC) does offer a higher milling resistance over alumina to preserve TED for the 300-250 nm range of TWD. But there are inherent difficulties in depositing a sufficient carbon film thickness to provide adequate TED protection, because as the film's thickness increases, stress may result in delamination or wafer bowing. Thus the ability to extend the P3 carbon process to track-width dimensions below 200 nm will be increasingly problematic. Moreover, at TWD below 200 nm, the pole piece will be fragile and removal of redeposited materials (milling nonvolatile by-products) on the top and sides of the pole tip will be increasingly more difficult.

Recently, it has been found that with pole tips that are extremely narrow and of greater length than width, there may be difficulties in stopping the magnetic flux after writing process has been completed. Magnetic flux may continue to flow from the pole tip even after the write current has been turned off. This residual flux can interfere with the completed data bits, causing unacceptable errors. In an effort to correct this condition, pole tips have been designed with laminated layers of magnetic and non-magnetic material, so that residual flux is channeled back from one magnetic laminate layer to a neighboring one, cutting short the extent of the residual flux flow and thus not interfering with the written data.

Although this design is effective in correcting the residual magnetic flux problem, there are other problems that can arise with the laminated pole structure. As discussed above, the P3 pole is generally configured as a trapezoid structure with the top plane wider than the lower. The track width is determined by the width of this upper plane, and it is very important that this dimension be very precisely controlled. However, there may be problems with the corners of the upper plane becoming rounded off or eroded during the fabrication process in a laminated structure, as well as problems with de-lamination of the layers.

A current fabrication procedure, as disclosed in co-pending application Ser. No. 10/676,728 by the current inventor, favors forming a sacrificial layer or hard mask layer on top of the P3 pole tip as it is shaped in order to protect the top edge. The dimension of the top edge of the P3 pole tip is crucial to establishing the track width. As the P3 pole tip is generally formed by ion milling, the sacrificial layer or hard mask is used to provide extra protection for this critical element. In addition, the shaped P3 pole with hard mask layer is then encapsulated in non-magnetic material, which gives support to the P3 pole and protects it from damage. One method of several possible methods using this approach is shown in FIGS. 5-9.

FIGS. 5-9 show the structure as seen from the ABS. In FIG. 5, the P2 magnetic pole shaping layer 44 has been deposited, but is not visible behind the alumina fill layer 48, as the P2 shaping layer does not extend to the ABS, as discussed above. The P3 pole tip 52 layer consists of multi-layers of high magnetic moment (Bₛ) material, such as CoFe or CoFeN or NiFe or their alloys and non-magnetic laminated pole material such as Cr, Al₂O₃, Ru, etc. Although these are alternating layers of differing materials, they have been shown as a common material with layering lines through it in the figure for ease of illustration. A layer of non-magnetic material which is resistant to ion milling, is formed such as a bilayer 63 having a bottom CMP stop layer 60 and a thin conductive layer 62, as shown in FIG. 5. The CMP stop layer 60 (bottom layer) is preferably made of Ta₂O₅, SiOₓN_{y}, Cr, NiCr, Ta or DLC or other CMP stop materials as are known in the art. The thin conductive layer 62 of Rh, Au, Pd or other conductive materials as are known in the art, form the top layer of the bilayer 63, and is used as a seed layer for forming the sacrificial layer, or hard mask layer, as shown and discussed below. A layer of photo-resist 64 of given thickness is put down on the bilayer 63, and a cavity 66 is photo-lithographically produced which will be filled in the next stage.

In FIG. 6, the cavity has been filled with material to form a sacrificial layer, also referred to as a hard mask 68. The material of this sacrificial layer is preferably NiP, although other plated materials, (both non-magnetic, and magnetic, as will be discussed later) with high ion milling resistance may also be used. The photo-resist layer 64 (see FIG. 5) is then removed, resulting in the structure seen in FIG. 6. This hard mask 68 layer is used as an ion mill mask 70 to pattern the P3 layer 52, (to be discussed below). When the hard mask 68 is trimmed to target track-width, the CMP stop layer 60 is also trimmed. The CMP stop layer 60 is used both as a mask when the P3 pole tip 52 is beveled, and as a CMP stop. The role of hard mask 68 is for patterning the write pole and transferring it to the CMP stop layer 60 and pole tip materials. The material for hard mask 68 is preferably non-magnetic so that traces of it can potentially be left in the head without interfering with the heads' performance. Moreover, it is desirable to plate hard mask 68 as thick as lithographically reasonable to achieve higher passivation and ion milling resistance.

In FIG. 7, ion milling is used to cut through the bilayer 63 and P3 layers 52. The trackwidth of hard mask 68 is preferably reduced before the ion milling of bilayer 63 and P3 pole tip 52 is started. By reducing the width of the hard mask layer 68, the width of the P3 pole tip layer 52, and bilayer 63 beneath are also reduced during ion milling.

Next ion milling is used again to bevel the sides of the P3 pole tip 52, as shown in FIG. 8. The hard mask 68 erodes slightly faster during this process, but the bilayer 63, which is preferably slightly higher in ion milling resistance than hard mask 68 acts as a secondary mask 72 so that the top edge 76 of the P3 pole tip 52 is protected, as shown in FIG. 8. The bilayer 63 is also used as a mask to bevel the pole piece.

As the trackwidth of the write pole shrinks, re-deposition and fencing on the side wall of the write pole 52 become a problem for removal since the pole tip 52 is so small (200 nm) and has a higher risk of being damaged. After the P3 write pole 52 is defined, it is then encapsulated in an encapsulation layer 74 such as Al₂O₃ or an insulator material, as shown in FIG. 9 (prior art). The encapsulation material 74 provides mechanical strength to the pole 52 and protects it from corrosion. Therefore, after defining the P3 write pole 52 with ion milling, the write pole 52, bilayer 63, and remaining hard mask 68 are encapsulated with an insulator such as alumina at a level just slightly below or at the same height as the CMP stop layer 60 of the bilayer 63. This is follow by a deposition of a thin layer of material of the same material as the CMP stop layer 60, which will be referred to as the encapsulation CMP stop layer 75.

Chemical Mechanical Polishing (CMP) is then used to remove or lift off the remaining hard mask 68. As discussed above, the encapsulating material 74 has a thin encapsulation CMP stop layer 75, so that as CMP is used to remove hard mask 68, the removal rate is selective toward hard mask 68 material. After a while, as CMP encounters the encapsulation CMP stop layer 75, the rate slows.

When the remaining hard mask layer 68 has been removed, the result is a planarized top surface of CMP stop layer 60 and encapsulation CMP stop layer 75 around the finished P3 pole tip 52, whose width preferably is on the order of 200 nm or less. Commonly, a layer of Diamond-Like Carbon (DLC) or a bilayer of Cr/Rh 90 is formed on the top layer of the P3 pole 52. Ideally the CMP process leaves the encapsulating material 74 above the DLC or Cr/Rh 90 layer, and the P3 pole is below the level of the encapsulating material 74, but there are often variations in the level of residual encapsulating material 74, so that elements near the edge of a wafer may have a different level than those near the center of a wafer. In elements in which the encapsulating material 74 is below the DLC or Cr/Rh 90 layer, the P3 pole may protrude above the encapsulating material 74, and the corners of the upper edge 76 may be eroded or otherwise damaged, as shown in FIG. 10A and in detail in FIG. 10B.

FIGS. 10A (prior art) and detail view FIG. 10B (prior art) shows the result of such damage to the P3 pole tip where it can be seen that the corners 78 are rounded at the top edge 76 of the pole. This top edge of the pole and back edge of sensor are the most critical head parameters. Any deterioration to the pole can destroy the usefulness of the pole and the entire run of heads may have to be scrapped.

In an effort to protect the pole from damage by the CMP process, attempts have been made to increase the thickness of the encapsulation layer to make the top pole surface lower than the encapsulation layer. However, the CMP slurry attacks alumina aggressively, and in experiments, the higher neighboring alumina still could not protect the pole from CMP damage. Attempts have also been made to balance the encapsulation layer thickness and CMP time, but the timing of the CMP process is difficult to control.

Thus, there is a need for a P3 pole tip structure which is protected from CMP erosion and for a method for protecting P3 pole tips for perpendicular recording from erosion by CMP processes.

### SUMMARY OF THE INVENTION

A preferred embodiment of the present invention is a magnetic head including a write head with an encapsulated protected pole structure, which includes a P3 pole tip. A protective layer surrounds at least a portion of the P3 pole tip, and an encapsulating material layer surrounds a portion of said protective layer. Also disclosed is a method of fabrication for a write head with an encapsulated protected pole structure.

It is an advantage of the present invention that the corners of the P3 pole tip are protected by the protective layer from erosion or damage.

It is a further advantage of the present invention that track width is more precisely controlled due to the protection of the P3 pole tip.

It is another advantage of the present invention that laminated layers in the P3 pole tip are protected by the protective layer from damage and de-lamination.

It is yet another advantage of the present invention that production yields are increased due to fewer damaged P3 pole tips during the fabrication process.

It is still another advantage of the present invention that it prevents corrosion of the P3 pole tip.

These and other features and advantages of the present invention will no doubt become apparent to those skilled in the art upon reading the following detailed description which makes reference to the several figures of the drawing.

### IN THE DRAWINGS

The following drawings are not made to scale as an actual device, and are provided for illustration of the invention described herein.

FIG. 1 shows a top plan view of an exemplary disk drive;

FIG. 2 illustrates a perspective view of view of an exemplary slider and suspension;

FIG. 3 shows a top plan view of an exemplary read/write head;

FIG. 4 is a side cross-sectional view depicting various components of the write head of a perpendicular head;

FIGS. 5-8 are front plan views of the Air Bearing Surface of a write head in various stages of fabrication;

FIGS. 9-10A are front plan views of the Air Bearing Surface of a write head of the prior art in various stages of fabrication;

FIG. 10B is a detail view of the P3 pole tip of the prior art showing erosion damage to the corners;

FIGS. 11-13A are front plan views of the Air Bearing Surface of a write head of the present invention in various stages of fabrication; and

FIG. 13B is a detail view of the P3 pole tip of the present invention showing the corners have been maintained in sharp condition.

### DETAILED DESCRIPTION OF THE PREFERRED EMBODIMENTS

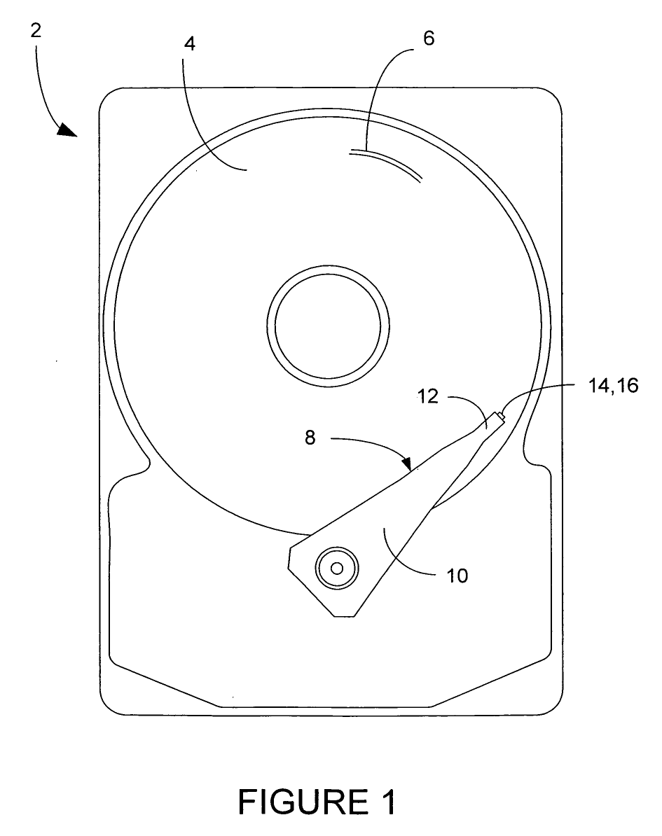

To aid in the understanding of the structures involved in the present invention, the following discussion is included with reference to FIGS. 1-4.

A magnetic disk drive 2 is shown generally in FIG. 1, having one or more magnetic data storage disks 4, with data tracks 6 which are written and read by a data read/write device 8. The data read/write device 8 includes an actuator arm 10, and a suspension 12 which supports one or more magnetic heads 14 included in one or more sliders 16.

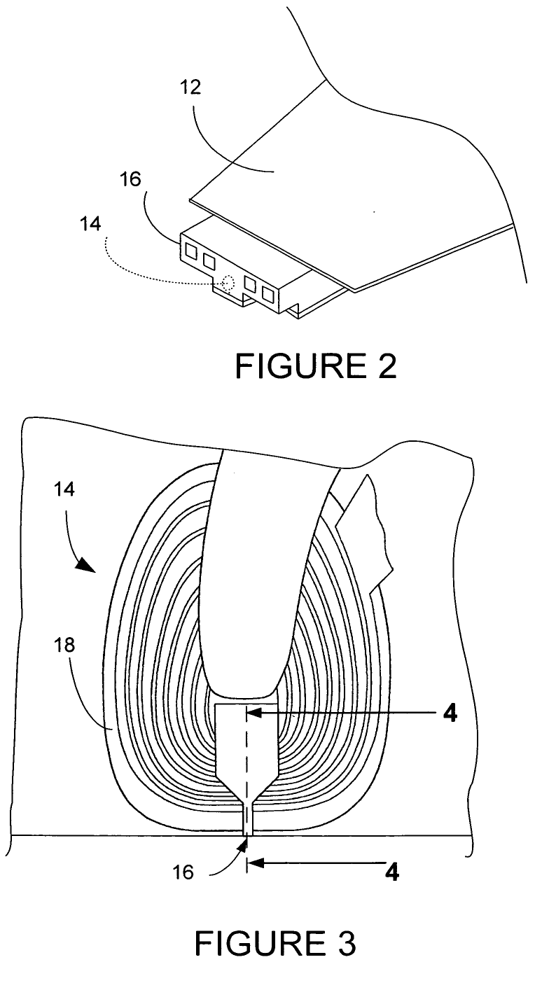

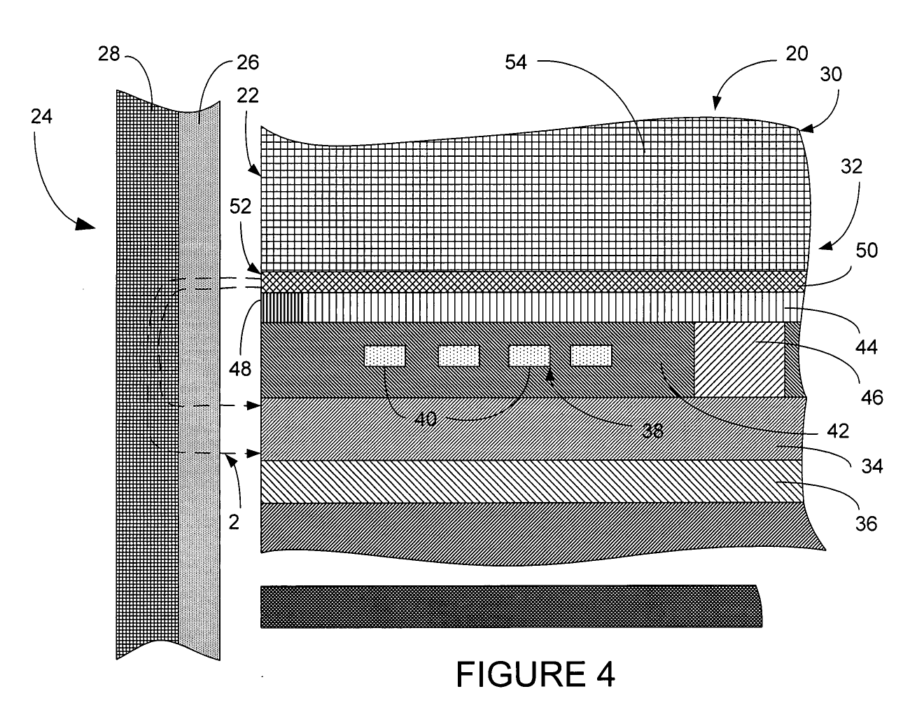

FIG. 2 shows a slider 16 in more detail being supported by suspension 12. The magnetic head 14 is shown in dashed lines, and in more detail in FIGS. 3 and 4. The magnetic head 14 includes a coil 18, and slider 16.

FIG. 4 (prior art) is a side cross-sectional diagram of the write head portion of a typical prior art perpendicular magnetic head. A slider 20 has an air bearing surface (ABS) 22 which flies above the surface of a hard disk 24. The disk 24 includes a high coercivity magnetic layer, also referred to the hard layer 26 that is fabricated on top of a magnetically soft layer 28.

The perpendicular head 30 typically includes a read head, which is not shown here. The write head portion includes a first magnetic pole P1 34 is fabricated upon an insulation layer 36. An induction coil structure 38, which includes coils 40, is fabricated upon the P1 pole 34. The coil turns 40 are typically formed within electrical insulation layers 42. A second magnetic pole layer, typically termed a P2 shaping layer 44, is fabricated on top of the induction coil structure 38. A magnetic back gap piece 46 joins the back portions of the P1 pole 34 and the P2 shaping layer 44, such that magnetic flux can flow between them. The P2 shaping layer 44 is fabricated so that a gap 48 is left between it and the rest of the ABS 22, and an alumina fill is deposited across the surface of the wafer which results in filling the gap 48 in front of the P2 shaping layer 44. A P3 layer 50, also called a probe layer, includes a P3 pole tip 52, and is in magnetic flux communication with the P2 shaping layer 44. The P2 shaping layer 44 channels and directs the magnetic flux into the P3 pole tip 52.

The magnetic head 30 is subsequently encapsulated, such as with the deposition of an alumina layer 54. Thereafter, the wafer is sliced into rows of magnetic heads, and the ABS surface of the heads is carefully polished and lapped and the discrete magnetic heads are formed.

Electrical current flowing through the induction coil structure 38 will cause magnetic flux 2 to flow through the magnetic poles 34, 52 of the head, where the direction of magnetic flux flow depends upon the direction of the electrical current through the induction coil. In one direction, current will cause magnetic flux 2 to flow through the P2 shaping layer 44 through the P3 layer 50 to the narrow pole tip 52 into the hard layer 26 and soft layer 28 of the hard disk 24. This magnetic flux 2 causes magnetized data bits to be recorded in the high coercivity layer hard layer 26 where the magnetic field of the data bits is perpendicular to the surface of the disk 24. The magnetic flux then flows into the magnetically soft underlayer 28 and disperse as it loops back towards the P1 pole 34. The magnetic flux 2 then flows through the back gap piece 46 to the P2 shaping layer 44, thus completing a magnetic flux circuit. In such perpendicular write heads, it is significant that at the ABS 22, the P1 pole 34 is much larger than the P3 pole tip 52 so that the density of the magnetic flux passing out from the high coercivity magnetic hard layer 26 is greatly reduced as it returns to the P1 pole layer 34 and will not magnetically affect, or flip, the magnetic field of data bits on the hard disk, such as bits on data tracks adjacent to the track being written upon.

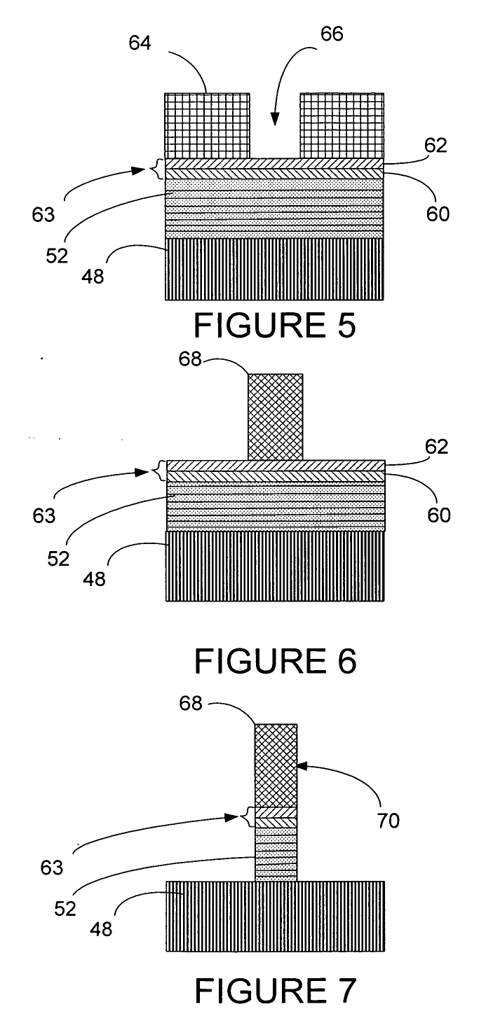

As discussed above, some current fabrication procedures favor forming a sacrificial layer or hard mask layer on top of the P3 pole tip as it is shaped in order to protect the top edge. The dimension of the top edge of the P3 pole tip is crucial to establishing the track width. As the P3 pole tip is generally formed by ion milling, the sacrificial layer or hard mask is used to provide extra protection for this critical element. In addition, the shaped P3 pole with hard mask layer is then encapsulated in non-magnetic material, which gives support to the P3 pole and protects it from damage. There are several methods of producing this configuration, the product of which is shown in FIG. 9. One method of several possible methods is shown and discussed above in regard to FIGS. 5-9.

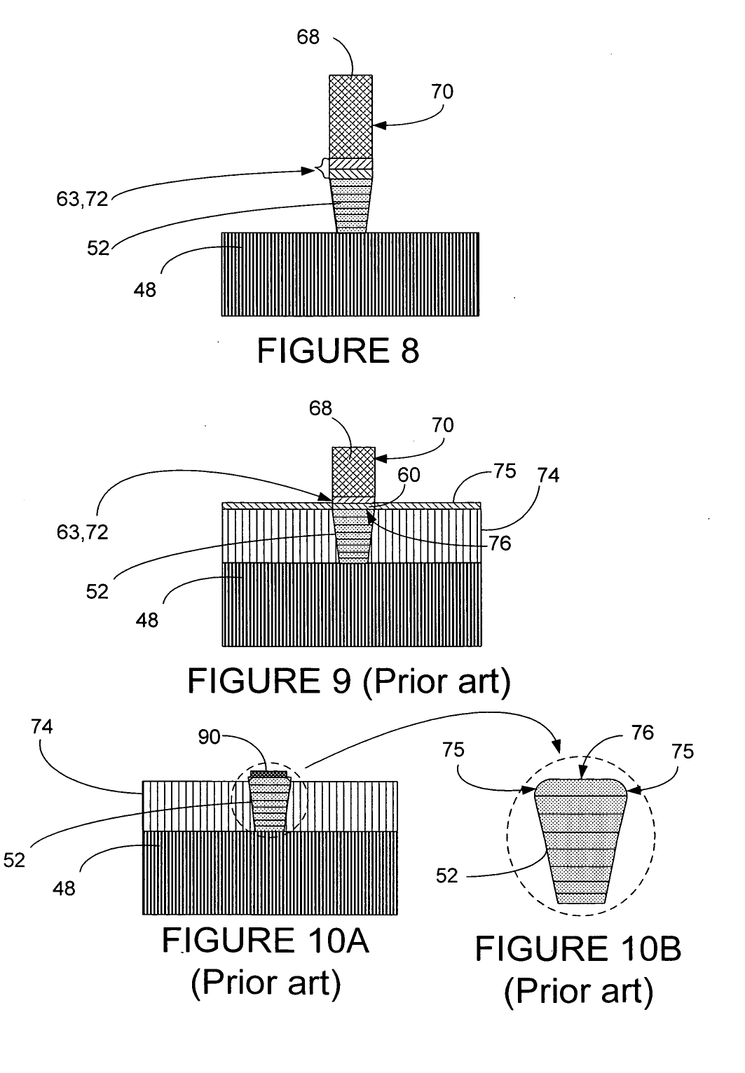

The present invention uses the stages illustrated and discussed above with regard to FIGS. 5-7 to arrive at the configuration seen in FIG. 8

As seen in FIG. 7, ion milling is used to cut through the layers of P3 pole tip material 52, and CMP stop layer 60. The trackwidth, as determined by of the width of the hard mask layer 68 is reduced before ion milling of CMP stop layer 60 and P3 pole tip 52 is started. Next, ion milling is used again to bevel the sides of the P3 pole tip 52, as shown in FIG. 8. The hard mask 68 erodes slightly faster during this process, but the CMP stop layer 60, which is preferably slightly higher in ion milling resistance than hard mask 68 acts as a secondary mask 72 so that the top edge 76 of the P3 pole tip 52 is protected, as shown in FIG. 8.

In the prior art as seen in FIGS. 9-10B, after the P3 write pole 52 is defined, it is enclosed in an encapsulating material layer 74 such as Al₂O₃ or other insulation materials such as Ta₂O₅, SiOxNy and other materials that are known in the art. The encapsulating material layer 74, generally alumina, is commonly followed with an optional layer of the same material as used in the CMP stop layer to make a second CMP material layer 90. As discussed above, a problem is encountered when using the Chemical Mechanical Polishing (CMP) assisted lift-off process. The CMP will polish off the higher topography area, which usually is the stack of photoresist with encapsulating material layer 74 and the second CMP material layer 90. However, CMP slurry is designed to attack alumina aggressively. Ideally the CMP process leaves the encapsulating material 74 above the second CMP material layer 90, and the P3 pole 52 is below the level of the encapsulating material 74, but there are often variations in the level of residual encapsulating material 74, so that elements near the edge of a wafer may have a different level than those near the center of a wafer. In elements in which the encapsulating material 74 is below the DLC or Cr/Rh 90 layer, the P3 pole may protrude above the encapsulating material 74, and the corners of the upper edge 76 may be eroded or otherwise damaged, as shown in FIG. 10A and in detail in FIG. 10B.

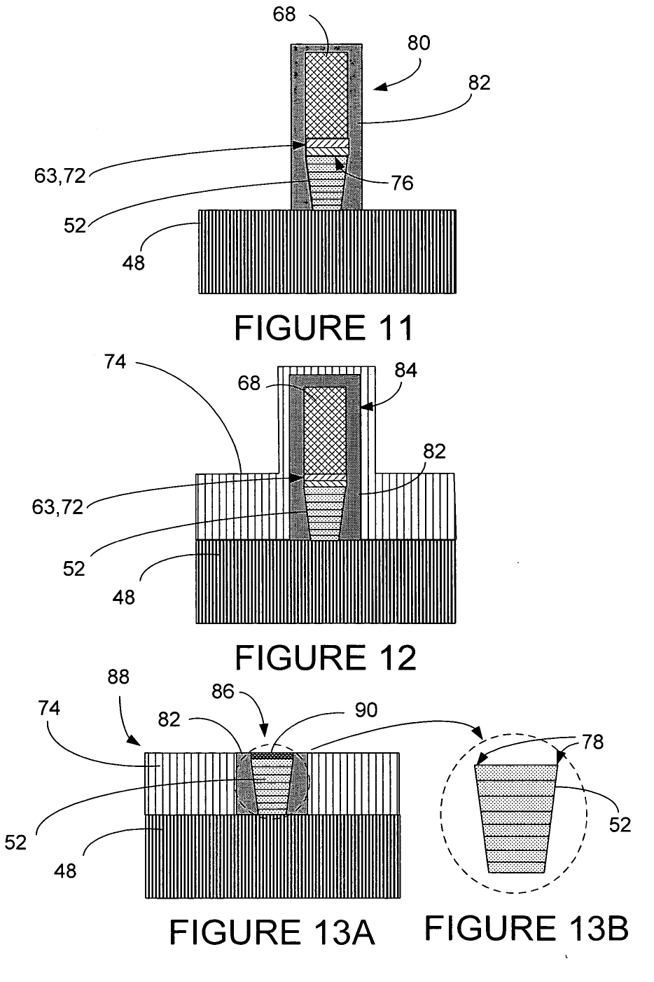

The present invention solves this problem by forming a non-magnetic protective layer to wrap around the P3 pole sidewall after ion milling or pole ion mill but prior to forming the encapsulating material layer. This protective layer will protect the pole structure from chemical attack during the CMP process. This process of the present invention is shown in FIGS. 11-13B.

FIG. 11 shows a laminated P3 pole tip 52, which has been shaped as in the previous description, above the alumina fill layer 48. The P3 pole tip 52 layer consists of multi-layers of high magnetic moment (Bₛ) such as CoFe, CoFeN, NiFe, CoFe alloys, CoFeN alloys, NiFe alloys and non-magnetic laminated pole material such as Cr, Al₂O₃, Ru, NiCr, and Rh.

A layer of non-magnetic material which is resistant to ion milling, such as a bilayer 63 having a bottom CMP stop layer 60 and a thin conductive layer 62, has been formed on the P3 pole tip 52. The CMP stop layer 60 (bottom layer) is preferably made of Ta₂O₅, SiOₓN_{y}, Cr, NiCr, Ta or DLC or other CMP stop materials as are known in the art. The thin conductive layer 62 of Rh, Au, Pd or other thin conductive materials as are known in the art, form the top layer of the bilayer 63, and is used as a seed layer for forming the sacrificial layer, or hard mask layer 68.

The bilayer 63, also acts as a secondary mask 72 and is in place on the upper edge 76 of the laminated P3 pole tip 52. The hard mask 68 is formed above the bilayer 63. The hard mask 68 is preferably of NiFe, NiP and plated materials with high ion milling resistances. For ease of reference, the P3 pole tip 52, bilayer 63 and hard mask 72 will be referred to collectively as the masked pole structure 80. This masked pole structure 80 has been encapsulated in a non-magnetic protective layer 82. This protective layer 82 is preferably made from Rh, Ru, SiO₂, Ta, Rh/Ta, DLC, NiCr, or Cr. Since the laminate structure of the P3 pole tip 52 layer consists of potentially corrosive materials such as CoFe, the nonmagnetic protective layer 82 material is preferably a material that can be in contact with the laminate materials and prevent it from corrosion. Thus, the protection layer 82 has two functions, first to physically protect the write pole from damage during CMP and second to chemically protect the write pole from corrosion.

FIG. 12 shows that the encapsulating material layer 74 has been formed around the masked pole structure 80, and surrounds the protective layer 82. The encapsulating material layer 74 is preferably Al₂O₃ or another insulator material. It will be understood that the encapsulating material layer 74 may cover the entire protective layer 82 as shown in the figure, or it may be masked off from forming on the upper portion 84 of the protective layer 82.

Next, the hard mask 68, the upper portion 84 of the protective layer 82, and the portion of the encapsulating material layer 74 above the CMP stop layer 60 are removed. The hard mask 68 is broken by CMP and lifted off, usually by application of hot NMP, a cleaning solution. Optionally, a second layer of CMP material 90 is next formed on the top of the P3 pole 52. A touch-up process of CMP is then done to planarize down to the level of the second CMP stop layer 90, and to remove fencing, which produces the result seen in FIG. 13A. The completed P3 pole tip 52, optional second layer of CMP material 90 and protective layer 82 will be referred to collectively as the protected pole structure 86. The protected pole structure 86 may also include all or a portion of the second CMP stop layer 90. A close-up detail view of the P3 pole tip 52 is shown in FIG. 13B, where it can be seen that the corners 78 are sharply defined and not rounded, as in the prior art.

The completed P3 pole tip 52, and protective layer 82 with encapsulating material layer 74 will be referred to collectively as the encapsulated protected pole structure 88.

While the present invention has been shown and described with regard to certain preferred embodiments, it is to be understood that modifications in form and detail will no doubt be developed by those skilled in the art upon reviewing this disclosure. It is therefore intended that the following claims cover all such alterations and modifications that nevertheless include the true spirit and scope of the inventive features of the present invention.

What is claimed is:

1. A magnetic head including a write head with a protected pole structure, comprising:
a P3 pole tip; and
a non-magnetic protective layer surrounding a portion of said P3 pole tip.

2. The magnetic head of claim 1, wherein:
said non-magnetic protective layer material is chosen from the group consisting of Rh, Ru, SiO₂, Ta, Rh/Ta, DLC, NiCr, and Cr.

3. The magnetic head of claim 1, wherein:
said P3 pole tip is a laminate structure with alternating layers of magnetic and non-magnetic material.

4. The magnetic head of claim 3, wherein:
said magnetic material of said laminate structure is chosen from the group consisting of CoFe, CoFeN, NiFe, CoFe alloys, CoFeN alloys, and NiFe alloys

5. The magnetic head of claim 3, wherein:
said non-magnetic material of said laminate structure is chosen from the group consisting of Cr, Al₂O₃, Ru, NiCr, and Rh.

6. The magnetic head of claim 1, further comprising:
a CMP stop layer material formed on said P3 pole tip.

7. The magnetic head of claim 4, wherein:
said CMP stop layer is a material chosen from the group consisting of Ta₂O₅ alloys, SiOₓN_{y} alloys, Nr, NiCr, Rh, Ta and DLC.

8. The magnetic head of claim 1, further comprising:
an encapsulating material layer surrounding a portion of said non-magnetic protective layer

9. The magnetic head of claim 6, wherein:
said encapsulating material is chosen from a group consisting of alumina and insulation materials

10. The magnetic head of claim 1, further comprising:
second layer of CMP material formed on said P3 pole tip.

11. A magnetic head including a write head with an encapsulated protected pole structure, comprising:
a P3 pole tip;
a protective layer surrounding at least a portion of said P3 pole tip; and
an encapsulating material layer surrounding a portion of said protective layer.

12. The magnetic head of claim 9, wherein:
said protective layer material is chosen from the group consisting of Rh, Ru, SiO₂, Ta, Rh/Ta, DLC, NiCr, and Cr.

13. The magnetic head of claim 9, wherein:
said P3 pole tip is a laminate structure with alternating layers of magnetic and non-magnetic material.

14. The magnetic head of claim 13, wherein:
said magnetic material of said laminate structure is chosen from the group consisting of CoFe, CoFeN, NiFe, CoFe alloys, CoFeN alloys, and NiFe alloys

15. The magnetic head of claim 13, wherein:
said non-magnetic material of said laminate structure is chosen from the group consisting of Cr, Al₂O₃, Ru, NiCr, and Rh.

16. The magnetic head of claim 9, further comprising:
a CMP stop layer material formed on said P3 pole tip.

17. The magnetic head of claim 16, wherein:
said CMP stop layer is a material chosen from the group consisting of Ta₂O₅ alloys, SiOₓN_{y} alloys, Nr, NiCr, Rh, Ta and DLC.

18. The magnetic head of claim 9, wherein:
said encapsulating material is chosen from a group consisting of alumina and insulation materials.

19. The magnetic head of claim 9, further comprising:
second layer of CMP material formed on top of said P3 pole tip.

20. A disk drive comprising:
at least one hard disk;
at least one magnetic head adapted to fly over said hard disk for reading data from said hard disk, said magnetic head including a write head with protected pole structure, including:
a P3 pole tip; and
a non-magnetic protective layer surrounding a portion of said P3 pole tip.

21. The disk drive of claim 16, wherein said write head with protected pole structure, further comprises:
an encapsulating material layer surrounding at least a portion of said non-magnetic protective layer.

22. The magnetic head of claim 16, wherein:
said non-magnetic protective layer material is chosen from the group consisting of Rh, Ru, SiO₂, Ta, Rh/Ta, DLC, NiCr, and Cr.

23. A method for fabricating a write head for perpendicular recording having an encapsulated protected pole structure, comprising:
A) fabricating a P1, coils and P2 layer;
B) forming a P3 layer on said P2 layer;
C) forming a CMP stop layer on said P3 layer;
D) forming at least one hard mask layer on said CMP stop layer;
E) shaping portions of said P3 layer into a P3 pole tip;
F) enclosing a portion of said P3 pole tip in a protective layer;
G) forming an encapsulating material layer around at least a portion of said protective layer;
H) removing said at least one hard mask layer; and
I) planarizing said encapsulating material.

24. The method of claim 23, wherein:
said protective layer of F comprises non-magnetic material.

25. The method of claim 24, wherein:
said non-magnetic protective layer material is chosen from the group consisting of Rh, Ru, SiO₂, Ta, Rh/Ta, DLC, NiCr, and Cr.

26. The method of claim 23, wherein:
said CMP stop layer material of C) is a material chosen from the group consisting of Ta₂O₅ alloys, SiOₓN_{y} alloys, Nr, NiCr, Rh, Ta and DLC.

27. The method of claim 23, wherein:
said at least one hard mask layer of D) comprises material chosen from the group consisting of NiFe, NiP and plated materials with high ion milling resistances.

28. The method of claim 23, wherein:
said P3 pole tip is a laminate structure with alternating layers of magnetic and non-magnetic material.

29. The method of claim 28, wherein:
said magnetic material of said laminate structure is chosen from the group consisting of CoFe, CoFeN, NiFe, CoFe alloys, CoFeN alloys, and NiFe alloys

30. The method of claim 28, wherein:
said non-magnetic material of said laminate structure is chosen from the group consisting of Cr, Al₂O₃, Ru, NiCr, and Rh.

31. The method of claim 23, wherein:
said shaping of said P3 layer of E) is done by ion milling.

32. The method of claim 23, wherein:
said encapsulating material is chosen from a group consisting of alumina and insulation materials.
